(19) United States
(12) Patent Application Publication
(10) Pub. No.: US 2009/0008961 A1
(43) Pub. Date: Jan. 8, 2009

(54) Fastening Apparatus

(75) Inventors: Peter Thomas, Schellbronn (DE); Helmut Eck, Rutesheim (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/168,303

(22) Filed: Jul. 7, 2008

(30) Foreign Application Priority Data
Jul. 6, 2007 (DE) 102007031607.2

(51) Int. Cl. B62D 37/02; B62D 35/00

(52) U.S. Cl. 296/180.1; 411/366.1; 411/166

(57) ABSTRACT

A fastening apparatus makes it possible for an additional wing to be fixed to a spoiler basic body via screws which are disposed in a concealed manner, such as a threaded screw and a threaded nut, the threaded screw being held in a manner which is captive in a cage and positionally fixed on the spoiler basic body, and ensuring positioning with respect to the threaded nut.

### CROSS-REFERENCE TO RELATED APPLICATION

This application claims the priority, under 35 U.S.C. § 119, of German application DE 10 2007 031 607.2, filed Jul. 6, 2007; the prior application is herewith incorporated by reference in its entirety.

### BACKGROUND OF THE INVENTION

### Field of the Invention

The invention relates to a fastening apparatus of an additional wing on a basic body of a two-part basic body of a rear spoiler. The additional wing extends between cheeks of the basic body and is mounted on a supporting face. At least one transversely extending air throughflow opening is provided between the basic body and the additional wing.

An additional wing of a rear spoiler is connected to the spoiler basic body in a known manner by the insertion of a threaded nut through an upper opening in the additional wing, the screw then, furthermore, being inserted through an opening into the basic body and being screwed into the threaded nut.

### SUMMARY OF THE INVENTION

It is accordingly an object of the invention to provide a fastening apparatus that overcomes the above-mentioned disadvantages of the prior art devices of this general type, which fastening apparatus makes simple mounting of the additional wing possible with the basic body of a spoiler.

With the foregoing and other objects in view there is provided, in accordance with the invention, a fastening apparatus for a hollow and closed additional wing on a two-part basic body of a rear spoiler for a motor vehicle. The additional wing extends between cheeks of the two-part basic body and is mounted on supporting faces. At least one transversely extending air throughflow opening is defined between the two-part basic body and the additional wing. The fastening apparatus contains screw connections for connecting free ends of the additional wing in a region of the supporting faces of the two-part basic body. The screw connections each having a cage and a threaded screw held in the cage. The cage is disposed within a hollow space of the two-part basic body. The hollow space of the two-part basic body is closed off by a covering shell of the rear spoiler. The screw connections further have a threaded nut held to correspond with the threaded screw being captive in the cage and disposed within a hollow space of the additional wing.

The advantages which are mainly achieved by way of the invention include it being possible for the additional wing to be mounted on the spoiler basic body by a prefixed fastening screw in the basic body in a simplified and quicker manner. This is achieved, in particular, by the fact that the additional wing is connected with its free ends in each case via a screw connection in the region of a supporting face of the basic body of the rear spoiler. The threaded screws is held in each case in a cage which is disposed within a hollow space of the basic body of the spoiler, which hollow space is closed off by a covering shell. A threaded nut which is held such that it corresponds with the threaded screw which is captive in the cage is provided within the hollow space of the additional wing, and the threaded nut is integrally formed or fastened on the additional wing in a stationary manner. Simple mounting of the rear wing on the basic body is made possible by the threaded nut which is inserted during the production of the hollow and closed additional wing and by the threaded screw, which is captive in a cage, in the basic body of the rear spoiler.

In order that a premounting position of the threaded screw in the basic body is ensured, the threaded screw which is captive in the cage of the spoiler basic body is held by way of its head such that it is supported on a web or an annular web of the cage in such a way that the free shaft end of the threaded screw is held in a positionally fixed manner in a premounting position in a through hole in the wall of the spoiler basic body. As a result of this, a situation is advantageously achieved during placing of the additional wing onto the supporting face of the basic body, in which situation the threaded screw can be screwed directly into the threaded nut and a reliable fastening position is achieved.

In order that a tool for the threaded screw can be inserted into the basic body, a covering shell which supports the basic body has a corresponding hole or opening which is disposed coaxially with respect to the threaded screw, and the screw can be screwed in by the tool from the premounting position into a fixed position and vice versa.

The additional wing with an inserted threaded nut and the spoiler basic body with an attached cage and threaded screw situated therein are produced together, subsequently the covering shell being connected to the basic body and the additional wing being connected fixedly to the basic body via the threaded screw. This achieves a situation where first an outer visible opening is no longer required in the additional wing and second the threaded nut is inserted in the hollow rear wing in a concealed manner. A closure plug is also no longer required on the upper side of the additional wing.

Other features which are considered as characteristic for the invention are set forth in the appended claims.

Although the invention is illustrated and described herein as embodied in a fastening apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF SEVERAL VIEWS OF THE DRAWING

FIG. 1 is a diagrammatic, sectional view through a spoiler in a connecting region between a spoiler basic body and an additional wing which is placed on it according to the invention; and

FIG. 2 is a diagrammatic, perspective view of the rear spoiler with the additional wing according to the invention.

### DETAILED DESCRIPTION OF THE INVENTION

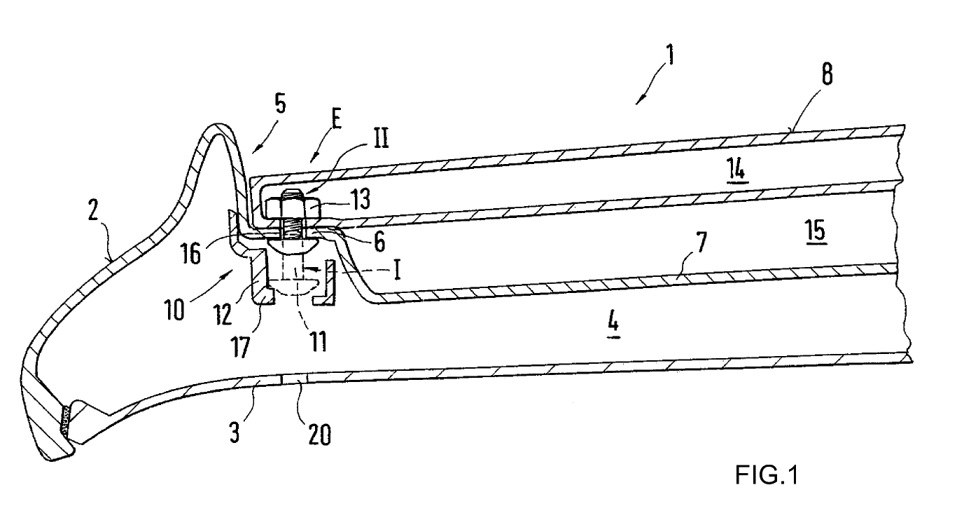

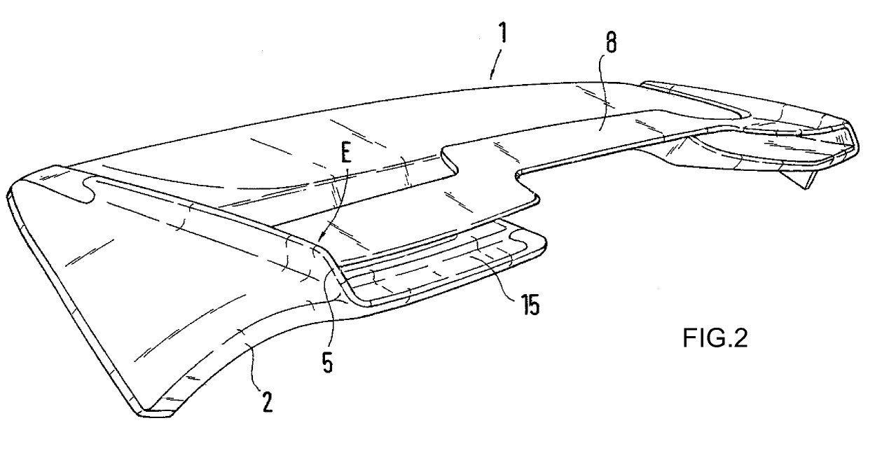

Referring now to the figures of the drawing in detail and first, particularly, to FIGS. 1 and 2 thereof, there is shown a rear spoiler 1 of a vehicle which substantially includes a basic body 2 having a covering shell 3 which encloses a hollow space 4. The basic body 2 has lateral cheeks 5 which form supporting faces 6 which are adjoined by a recessed wall 7. Free ends E of a transversely extending additional wing 8 are held on the supporting faces 6. The additional wing 8 is connected fixedly to the basic body 2 in the supporting region (supporting face 6) in each case via a fastening apparatus 10 which contains a threaded screw 11 in a cage 12 on the basic body and a threaded nut 13 in the additional wing 8. The additional wing 8 contains a hollow body which has a hollow space 14 and is held at a spacing from the wall 7, an intermediate space 15 which is formed resulting in an air throughflow opening.

During the production of the additional wing 8, the threaded nut 13 is placed in the hollow space 14 and fixed. The cage 12 including the threaded screw 11 is fastened in a region of the supporting face 6 when the covering shell 3 is not yet fastened to the basic body 2.

The threaded screw 11 is captive in the cage 12 and lies with its shaft end in a hole 16 of the wall of the supporting face 6 in the premounting position I and is therefore held in a positionally fixed manner with respect to the threaded nut 13. The head of the threaded screw 11 is supported on an edge 17 of the cage 12 in this premounting position I.

The additional wing 8 of the rear spoiler 1 is preferably mounted in such a way that it is placed onto the supporting faces 6 and the threaded screw 11 which is captive in the cage 12 is screwed by a tool from the premounting position I into the fastening position II. Releasing takes place correspondingly in the reverse order.

A relatively small hole 20, through which the tool can be inserted and operated from the outside, is provided in the covering shell 3 in order to insert the tool via the basic body 2 which is closed by the covering shell 3.

1. A fastening apparatus for a hollow and closed additional wing on a two-part basic body of a rear spoiler for a motor vehicle, the additional wing extending between cheeks of the two-part basic body and being mounted on supporting faces, and at least one transversely extending air throughflow opening being defined between the two-part basic body and the additional wing, the fastening apparatus comprising:
screw connections for connecting free ends of the additional wing in a region of the supporting faces of the two-part basic body, said screw connections each having a cage and a threaded screw being held in said cage, said cage disposed within a hollow space of the two-part basic body, the hollow space of the two-part basic body being closed off by a covering shell of the rear spoiler, said screw connections further having a threaded nut held to correspond with said threaded screw being captive in said cage and disposed within a hollow space of the additional wing.

2. The fastening apparatus according to claim 1, wherein:
said threaded screw has a head and a free shaft end;
said cage is disposed in the two-part basic body and has a web; and
said threaded screw being captive in said cage is held by way of said head such that said threaded screw is supported on said web of said cage in a premounting position such that said free shaft end of said threaded screw is held in a positionally fixed manner in a through hole of a wall of the two-part basic body.

3. The fastening apparatus according to claim 1, wherein the covering shell has a hole formed therein for a passage of a tool and the hole is disposed coaxially with respect to said threaded screw, said threaded screw can be transferred by use of the tool from the premounting position into a fixed position and vice versa.

4. The fastening apparatus according to claim 1, wherein:
the additional wing is produced with said threaded nut inserted therein;
the two-part basic body is produced with said cage attached therein and has said threaded screw situated therein; and
subsequently the covering shell is connected to the two-part basic body and the additional wing is fastened to the two-part basic body via said threaded screw.

5. The fastening apparatus according to claim 2, wherein said web is an annular web.

6. A rear spoiler for a motor vehicle, the rear spoiler comprising:
a two-part basic body having cheeks, supporting surfaces, and a hollow space formed therein;
a covering shell closing off said hollow space of said two-part basic body;
an additional wing disposed on said two-part basic body and having free ends and a hollow space formed therein, said additional wing extending between said cheeks of said two-part basic body and being mounted on said supporting faces, and at least one transversely extending air throughflow opening being defined between said two-part basic body and said additional wing; and
a fastening apparatus containing screw connections for connecting said free ends of said additional wing disposed in a region of said supporting faces of said two-part basic body, said screw connections each having a cage and a threaded screw being held in said cage, said cage disposed within said hollow space of said two-part basic body, said screw connections further having a threaded nut held to correspond with said threaded screw held captive in said cage and disposed within said hollow space of said additional wing.

7. The fastening apparatus according to claim 6, wherein:
said threaded screw has a head and a free shaft end;
said cage is disposed in said two-part basic body and has a web;
said two-part basic body has a wall with a through hole formed therein; and
said threaded screw which is captive in said cage is held by way of said head such that said threaded screw is supported on said web of said cage in a premounting position such that said free shaft end of said threaded screw is held in a positionally fixed manner in said through hole of said wall of said two-part basic body.

8. The fastening apparatus according to claim 6, wherein said covering shell has a hole formed therein for a passage of a tool and said hole is disposed coaxially with respect to said threaded screw, said threaded screw can be transferred by use of the tool from the premounting position into a fixed position and vice versa.

9. The fastening apparatus according to claim 6, wherein:
said additional wing is produced with said threaded nut inserted therein;
said two-part basic body is produced with said cage attached therein and has said threaded screw situated therein; and
subsequently said covering shell is connected to said two-part basic body and said additional wing is fastened to said two-part basic body via said threaded screw.

10. The fastening apparatus according to claim 6, wherein said web is an annular web.
